(19) United States
(12) Patent Application Publication
(10) Pub. No.: US 2026/0276841 A1
(43) Pub. Date: Sep. 17, 2026

(54) RADIATION MEASURING DEVICE, RADIATION MEASURING METHOD, RADIATION MEASURING PROGRAM, INTERNAL BODY TISSUE MOVEMENT METHOD, AND NON-TRANSITORY RECORDING MEDIUM

(71) Applicants: NATIONAL INSTITUTES FOR QUANTUM SCIENCE AND TECHNOLOGY, Chiba (JP); MIRAI-IMAGING CORPORATION., Fukushima (JP)

(72) Inventors: Taiga YAMAYA, Chiba (JP); Ryotaro OHASHI, Chiba (JP); Miwako TAKAHASHI, Chiba (JP); Shigeki ITO, Fukushima (JP)

(21) Appl. No.: 18/873,921

(22) PCT Filed: May 26, 2023
(86) PCT No.: PCT/JP2023/019622

§ 371 Date: Dec. 11, 2024

(30) Foreign Application Priority Data
Jun. 16, 2022 (JP) 2022-097493

(51) Int. Cl. G01T 1/161; G01T 1/167

(52) U.S. Cl. CPC G01T 1/161; G01T 1/167

(57) ABSTRACT

A radiation measuring device (1) is a radiation measuring device (1) which is of a forceps type and which measures radiation from a body tissue, the radiation measuring device (1) including: a pair of radiation detecting sections (10) each of which includes a plurality of radiation detecting elements; and a correcting section (20) which estimates a position of a source of radiation from detection data obtained by the pair of radiation detecting sections and which corrects detection sensitivity of the pair of radiation detecting sections with respect to the radiation on the basis of the position of the source of the radiation that has been estimated.

### TECHNICAL FIELD

The present invention relates to a radiation measuring device, a radiation measuring method, a radiation measuring program, a body tissue moving method, and a non-transitory recording medium.

### BACKGROUND ART

As a conventional technique, there has been known a method of diagnosing metastasis of cancer to, for example, a lymph node with use of a positron emission tomography (PET) test drug. As the PET test drug, there are ¹⁸F-fluorodeoxyglucose (FDG), a prostate specific membrane antigen (PSMA), and the like. In order to determine the presence or absence of metastasis to a lymph node by this method, a body insertion type radiation detecting section has been developed. For a reduction in load on a human body, i.e., so-called low invasiveness, the device which is inserted into the body during an operation so as to diagnose metastasis to a lymph node and/or the like is preferably insertable into the body via, for example, a trocar or the like.

For example, Non-Patent Literature 1 discloses measuring the radioactivity concentration of a lymph node with use of a forceps type coincidence counter that is insertable into a body. According to Non-Patent Literature 1, the forceps type coincidence counter, in which two radiation detecting elements between which a lymph node can be sandwiched are disposed, makes it possible to eliminate background gamma rays and detect metastasis to each lymph node. Non-Patent Literature 2 discloses a forceps type coincidence counter in which a pair of small-sized scintillation-type detectors are mounted on an extreme end thereof and which is assumed to be used endoscopically.

Non-Patent Literature 3 discloses a radiation measuring device that includes a detector which is divided into a plurality of parts, i.e., that includes a probe type radiation detecting section in which a plurality of detecting elements are disposed and that is small-sized so as to be inserted into a body. With this radiation measuring device, it is possible to measure a simple distribution of a source of radiation.

### CITATION LIST

### Non-Patent Literature

[Non-patent Literature 1]
TAKAHASHI, Miwako. “Jutsuchu Rimpasetsu Kakuigaku Shindan (Nuclear medicine for intraoperative lymph node diagnosis)”, 2020 Report on PET Imaging Physics Research, pp. 83-90 (2021).
[Non-patent Literature 2]
OHASHI, Ryotaro. “Kanshigata Mini PET no kandobumpu no shimyureshon (Sensitivity simulation of the forceps-type mini-PET)”, 2021 Report on PET Imaging Physics Research, pp. 81-84 (2022).
[Non-patent Literature 3]
Abolaban, F., Alhawsawi, A. “Intraoperative Gamma Probe for Locating Cancerous Lymph Nodes”, Arab J Sci Eng 46, 713-719 (2021).

### SUMMARY OF INVENTION

### Technical Problem

However, the device disclosed in Non-Patent Literature 3 is not a device which carries out coincidence counting but a device in which a measurement target is a single photon and which measures only incidence of radiation from a single direction. Thus, the device disclosed in Non-Patent Literature 3 can obtain a simple distribution of a source of radiation, but cannot estimate radioactivity quantitatively. The technique disclosed in each of Non-Patent Literatures 1 and 2 is a coincidence counter in which two detecting elements are disposed so as to face each other. Therefore, detection sensitivity to radiation varies depending on the position of a source of the radiation. Accordingly, in a case where a measured value is used as it is, there is a possibility that radioactivity cannot be accurately estimated.

In view of the above problems, an object of an aspect of the present invention is to provide a technique of obtaining a measured value for accurately estimating radioactivity in a case where coincidence counting type radiation detecting sections are used.

### Solution to Problem

In order to attain the above object, a radiation measuring device in accordance with an aspect of the present invention is a radiation measuring device which is of a forceps type and which measures radiation from a body tissue, including: a pair of radiation detecting sections each of which includes a plurality of radiation detecting elements; and a correcting section which estimates a position of a source of radiation from detection data obtained by the pair of radiation detecting sections and which corrects detection sensitivity of the pair of radiation detecting sections with respect to the radiation on the basis of the position of the source of the radiation that has been estimated.

In order to attain the above object, a radiation measuring method in accordance with an aspect of the present invention is a radiation measuring method for measuring radiation from a body tissue, including the steps of: estimating a position of a source of radiation from detection data obtained by a pair of radiation detecting sections each of which includes a plurality of radiation detecting elements; and correcting detection sensitivity of the pair of radiation detecting sections with respect to the radiation on the basis of the position of the source of the radiation that has been estimated.

The present invention also encompasses, in its scope, (i) a radiation measuring program for causing a computer to realize the correcting section of the above radiation measuring device and (ii) a computer-readable recording medium in which the radiation measuring program is recorded.

### Advantageous Effects of Invention

According to an aspect of the present invention, it is possible to obtain a measured value for accurately estimating radioactivity in a case where coincidence counting type radiation detecting sections are used.

### BRIEF DESCRIPTION OF DRAWINGS

FIG. 1 is a block diagram illustrating a configuration of a radiation measuring device in accordance with Embodiment 1 of the present invention.

FIG. 2 is a flowchart illustrating a flow of a radiation measuring method in accordance with Embodiment 1 of the present invention.

FIG. 3 is a schematic view illustrating the principle of measurement of radiation from a PET test drug.

FIG. 4 is a schematic view illustrating that detection sensitivity varies depending on disposition of a pair of radiation detecting sections and a source.

FIG. 5 is a schematic view illustrating another example in which the detection sensitivity varies depending on the disposition of the pair of radiation detecting sections and the source.

FIG. 6 is a schematic view illustrating a difference in parameter of the sensitivity of detecting elements which difference is caused by a difference in method of opening and closing of the radiation detecting sections.

FIG. 7 includes a schematic view illustrating a case where each of the pair of radiation detecting sections is divided into four elements and a table showing combinations of elements with which coincidence counting of the radiation is carried out.

FIG. 8 is a schematic view illustrating another example of the number of elements into which each of the radiation detecting sections is divided.

FIG. 9 is a graph showing changes in rate of measurement of the radiation which changes are caused by the position of the source.

FIG. 10 is a schematic view illustrating the other examples of a position at which each of the radiation detecting sections is divided into the elements.

FIG. 11 is a schematic view illustrating that counts in combinations of the detecting elements vary depending on the position of the source.

FIG. 12 is a conceptual diagram illustrating a configuration of a position estimation model.

FIG. 13 is a schematic view illustrating the position of the source which position is outputted by the position estimation model.

FIG. 14 is a schematic view illustrating a concept of correction carried out by a correcting section.

FIG. 15 is a flowchart illustrating a flow of a body tissue moving method.

FIG. 16 is a schematic view illustrating detection data obtained by the radiation detecting sections and a concept of correction of the detection data.

FIG. 17 is a graph showing a result of training the position estimation model.

FIG. 18 includes graphs each showing accuracy of estimation which the position estimation model carried out in each axial direction with respect to all data on coincidence count values.

FIG. 19 is a histogram of estimated values of radioactivity before and after sensitivity correction.

### DESCRIPTION OF EMBODIMENTS

### Embodiment 1

Before a radiation measuring device in accordance with an embodiment of the present invention is described in detail, the necessity of the radiation measuring device in accordance with the present embodiment is described.

In a case where metastasis of cancer is diagnosed, a false negative (being incorrectly diagnosed as a negative, although actual diagnosis is a positive) should be avoided as much as possible. However, metastasis of cancer to a body tissue is irregularly distributed and, therefore, a site in which a PET test drug is accumulated (affected site) also becomes irregular. Then, in a case where a coincidence counting technique is used, detection sensitivity varies depending on which parts of radiation detecting sections detect radiation, i.e., the position of a source of the radiation (hereinafter also simply referred to as a “source”), due to the principle of the coincidence counting technique. Therefore, in a case where a measured value is interpreted while the detection sensitivity is regarded as being uniform, there is a possibility of an increase in false negative. The radiation measuring device in accordance with the present embodiment corrects the sensitivity of radiation detecting sections in accordance with the position of a source.

### (Radiation Measuring Device 1)

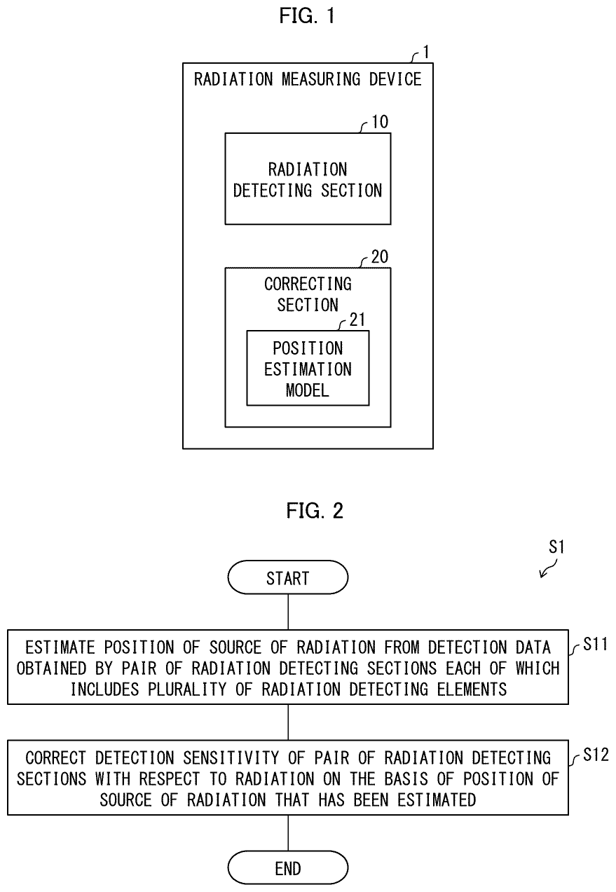

FIG. 1 is a block diagram illustrating a configuration of a radiation measuring device 1 in accordance with Embodiment 1. The radiation measuring device 1 is a radiation measuring device which is of a forceps type and which measures radiation from a body tissue. The forceps type means a measuring device which has a shape of a medical forceps for holding and in which radiation detecting elements are disposed at a holding part located at an extreme end thereof. More specifically, the radiation measuring device 1 is a radiation measuring device in which radiation detecting sections 10 are respectively provided at two openable and closable end parts of a medical forceps for holding. The radiation measuring device 1 as described above can be used in such a manner as to be inserted into an abdominal cavity, a thoracic cavity, or the like via a trocar or the like. In this case, the radiation measuring device 1 is configured to have a diameter that is made small to such a degree that the radiation measuring device 1 can be inserted into the trocar.

The body tissue is, in the present embodiment, a lymph node as an example. In a case where FDG is used as a PET test drug, cancerous cells that have metastasized to a lymph node and/or the like generally tend to have FDG accumulated therein. Thus, by measuring radiation emitted from FDG, it is possible to measure at what level cancerous cells are contained in a lymph node and/or the like. Note, however, that the body tissue only needs to be an organ in which a source of annihilation gamma rays, such as FDG, is accumulated, and is not limited to a lymph node.

As illustrated in FIG. 1, the radiation measuring device 1 includes the radiation detecting sections 10 and a correcting section 20. The radiation detecting sections 10 are constituted by a pair of radiation detecting sections 10A and 10B, and each of the pair of radiation detecting sections 10A and 10B includes a plurality of radiation detecting elements. The radiation detecting sections 10 are constituted by the pair of radiation detecting sections 10A and 10B in order to measure annihilation gamma rays, as described later. The radiation detecting elements can be, for example, scintillation detecting elements, semiconductor detecting elements, or the like. The scintillation detecting elements can be CsI(Tl) scintillators, NaI(Tl) scintillators, or the like. The semiconductor detecting elements can be CdTe(CZT) semiconductor detecting elements, Si semiconductor detecting elements, Ge semiconductor detecting elements, or the like. Hereinafter, the radiation detecting elements are also simply referred to as “detecting elements”.

The correcting section 20 estimates the position of a source of radiation from detection data obtained by the pair of radiation detecting sections 10, and corrects the detection sensitivity of the pair of radiation detecting sections with respect to the radiation on the basis of the position of the source of the radiation that has been estimated. As illustrated, the correcting section 20 may include a position estimation model 21. The position estimation model 21 is, as described later, a model which has been trained by machine learning so as to estimate the position of the source of the radiation detected by the radiation detecting sections 10.

Note that, in FIG. 1, the radiation detecting sections 10, the correcting section 20, and the position estimation model 21 are illustrated as being included in a single housing, but a configuration of the radiation measuring device 1 is not limited to this. For example, the correcting section 20 and/or the position estimation model 21 may be disposed in a place different from a place in which the radiation detecting sections 10 are disposed, such that the correcting section 20 and/or the position estimation model 21 can carry out information communication with the radiation detecting sections 10. Then, the detection data obtained by the radiation detecting sections 10 may be transmitted to the correcting section 20, and the data may be transmitted from the correcting section 20 to the position estimation model 21. Note also that the correcting section 20 and/or the position estimation model 21 may be disposed on a cloud. Then, the detection data that has been corrected may be transmitted to an output section provided to the radiation measuring device 1 or to a display device and/or the like provided outside the radiation measuring device 1.

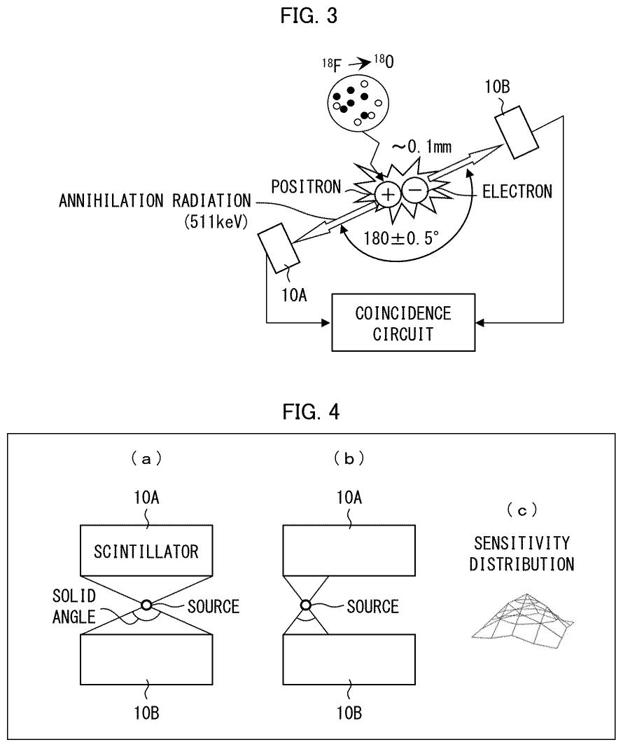

FIG. 3 is a schematic view illustrating the principle of measurement of radiation from FDG. ¹⁸F contained in FDG emits positrons and decays, so that ¹⁸F changes to ¹⁸O. The emitted positrons quickly bind to electrons and, consequently, pair annihilation occurs. At this time, generated energy is emitted and measured as two annihilation gamma rays. The annihilation gamma rays are generated simultaneously in the directions at approximately 180 degrees due to the law of conservation of momentum. Therefore, it is possible to detect the annihilation gamma rays with use of the pair of radiation detecting sections 10A and 10B and a coincidence circuit. Specifically, the radiation detected almost simultaneously (within a given time period) by the radiation detecting sections 10A and 10B is counted as the annihilation gamma rays. The number of annihilation gamma rays is proportional to the amount of the source (radioactivity), but all the annihilation gamma rays cannot be always detected by the radiation detecting sections 10A and 10B. This is a reason why the detection sensitivity occurs. Hereinafter, the “annihilation gamma rays” are also simply referred to as “radiation”.

Next, correction of the detection sensitivity carried out by the correcting section 20 is described. FIG. 4 is a schematic view illustrating that the detection sensitivity varies depending on disposition of the pair of radiation detecting sections (for example, scintillators) 10A and 10B and the source. FIG. 4 illustrates an example of parallel opening and closing in which the pair of radiation detecting sections 10A and 10B are opened and closed in a state of being parallel to each other. Only in a case where the source of the radiation is present between the radiation detecting sections 10A and 10B, the radiation detecting sections 10 can detect the radiation with use of the coincidence circuit. Note, however, that detection efficiency varies depending on the position of the source, due to the detection principle. Specifically, as illustrated in (a) of FIG. 4, in a case where the source is located in the vicinity of the centers of the radiation detecting sections 10A and 10B, a solid angle at which coincidence counting of the radiation can be carried out is large. In other words, a range in which coincidence counting of the radiation from the source can be carried out is wide. In contrast, as illustrated in (b) of FIG. 4, in a case where the source is located at a position away from the centers of the radiation detecting sections 10A and 10B, the solid angle at which coincidence counting of the radiation can be carried out is small. In other words, the range in which coincidence counting of the radiation from the source can be carried out is narrow. Therefore, as illustrated in (c) of FIG. 4, a sensitivity distribution is such that the sensitivity becomes higher as the position of the source becomes closer to the centers and the sensitivity becomes lower as the position of the source becomes closer to ends.

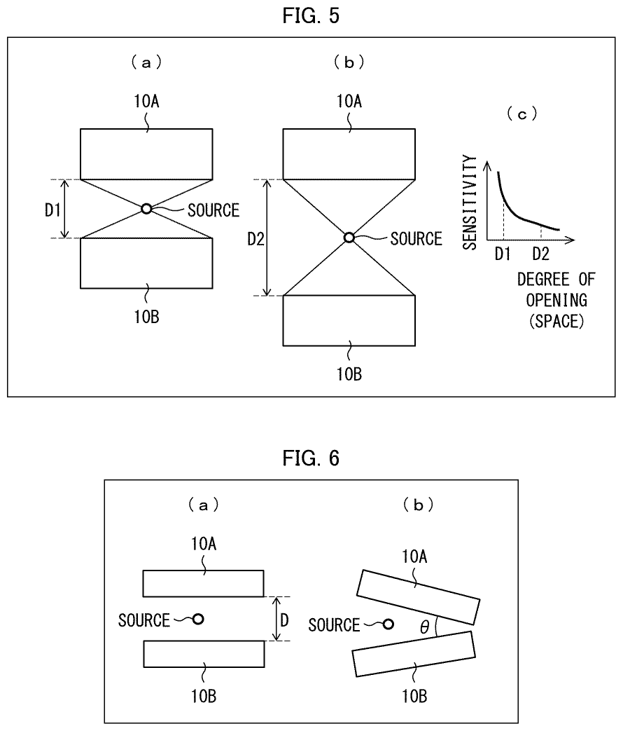

FIG. 5 is a schematic view illustrating another example in which the detection sensitivity varies depending on the disposition of the pair of radiation detecting sections 10A and 10B and the source. As illustrated in (a) of FIG. 5, in a case where the degree of opening is relatively small (D1), the solid angle at which coincidence counting of the radiation from the source can be carried out is large. In contrast, as illustrated in (b) of FIG. 5, in a case where the degree of opening is relatively large (D2), the solid angle at which coincidence counting of the radiation from the source can be carried out is small. Therefore, as illustrated in (c) of FIG. 5, the sensitivity distribution is such that the sensitivity becomes lower as the degree of opening becomes larger.

FIG. 6 is a schematic view illustrating a difference in parameter of the sensitivity of the detecting elements which difference is caused by a difference in method of opening and closing of the radiation detecting sections 10A and 10B. (a) of FIG. 6 illustrates a parallel opening and closing method in which a distance D varies in a state in which the radiation detecting sections 10A and 10B are parallel to each other, as illustrated in FIG. 5. In this case, the distance D and the position of the source are each the parameter of the sensitivity. (b) of FIG. 6 illustrates is a method in which the radiation detecting sections 10A and 10B are opened and closed on an axis like scissors. In this case, since the degree of opening varies depending on an opening and closing angle θ, the opening and closing angle θ and the position of the source are each the parameter of the sensitivity.

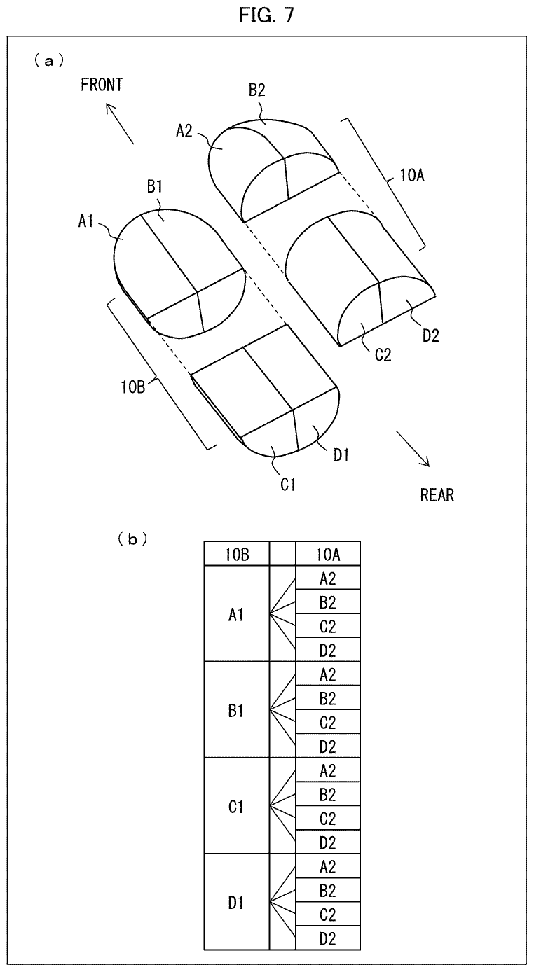

FIG. 7 is a schematic view illustrating a case where the radiation detecting section 10A is divided into four detecting elements A2, B2, C2, and D2 and the radiation detecting section 10B is divided into four detecting elements A1, B1, C1, and D1. (a) of FIG. 7 illustrates the radiation detecting sections 10A and 10B as obliquely viewed from the sides thereof, with each part located on the handle side of the radiation measuring device 1 regarded as a “rear part” and each part located on the extreme end side of the radiation measuring device 1 regarded as a “front part”.

(b) of FIG. 7 illustrates combinations of the detecting elements with which coincidence counting of the radiation is carried out, in a configuration in which each of the radiation detecting sections 10A and 10B is divided into two elements in the front-to-rear direction and two elements in the side-to-side (left-right) direction such that a total of four elements are disposed. The “side” indicates a view from the lateral direction perpendicular to the front-to-rear direction. In a case where each of the radiation detecting sections 10A and 10B is constituted by a total of four elements, i.e., two elements in the front-to-rear direction and two elements in the side-to-side direction, there are a total of 16 combinations of 4 detecting elements A1, B1, C1, and D1 and 4 detecting elements A2, B2, C2, and D2.

By each of the radiation detecting sections 10A and 10B being constituted by the plurality of detecting elements, the accuracy of estimation of the position of the source is improved. However, while it is preferable that the size (volume) of a single detecting element be larger, it is preferable that the overall sizes of the radiation detecting sections 10A and 10B be smaller in consideration of a case where the radiation detecting sections 10A and 10B are inserted into an abdominal cavity or the like via a trocar or the like. In consideration of such constraints, the number of elements into which each of the radiation detecting sections 10A and 10B is divided is determined.

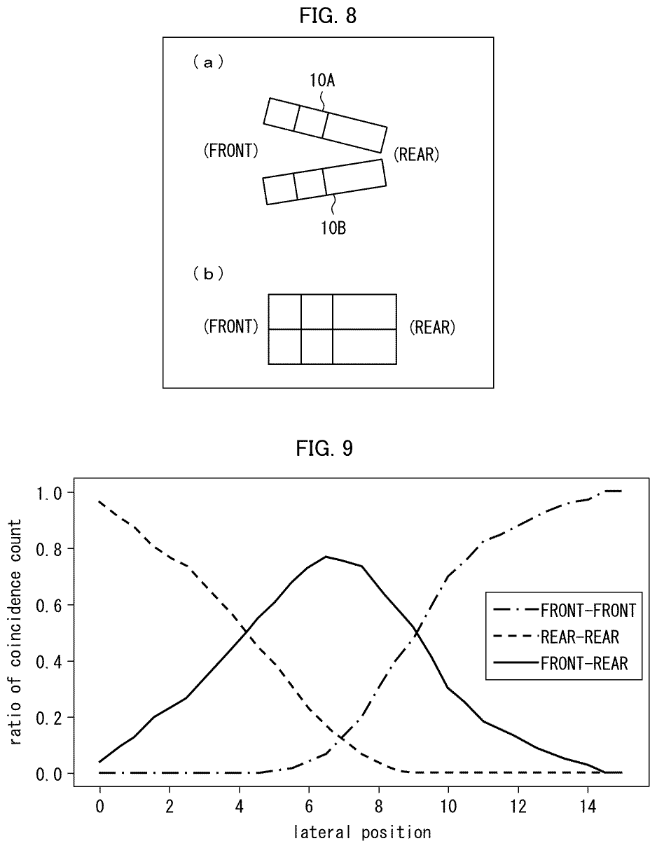

FIG. 8 illustrates an example in which each of the radiation detecting sections 10A and 10B is divided into six elements. Then, the front parts are more finely divided. It is not always necessary that, as in the example illustrated in (a) of FIG. 7, the volumes of the detecting elements in the front parts be equal to the volumes of the detecting elements in the rear parts, and the sizes of the detecting elements may be changed. For example, in a case where a forceps is actually used, an affected site is often sandwiched between the front parts of the forceps. By finely dividing the front parts, it is possible for the front parts, between which an affected site is frequently sandwiched, to have an improved ability of discriminating the position of the source.

FIG. 9 is a graph showing changes in rate of measurement of the radiation which changes are caused by the position of the source, in the case of the radiation detecting sections 10A and 10B illustrated in (a) of FIG. 7. Note, however, that the sizes of the four detecting elements are assumed to be equal. The horizontal axis indicates the position of the source, and indicates that the position of the source is located more frontward as the number becomes higher. The vertical axis indicates the ratio of coincidence counts measured. The line of “front-front” in FIG. 9 indicates the count ratio of the radiation measured with the elements located in the front parts of the radiation detecting sections 10A and 10B, such as A1-A2 and A1-B2. The line “rear-rear” indicates the count ratio of the radiation measured with the elements located in the rear parts, such as C1-C2 and C1-D2. The line “front-rear” indicates the count ratio of the radiation measured with the elements located in the front parts and the elements located in the rear parts, such as A1-C2 and A1-D2. Excluding a case where the position of the source is located at end parts, the count ratio of the radiation measured with the elements located in the front parts and the elements located in the rear parts is high on average. In a case where the source is located around the positions at which division into the elements is made, the accuracy of estimation increases because counts are widely dispersed over 16 combinations of the detecting elements.

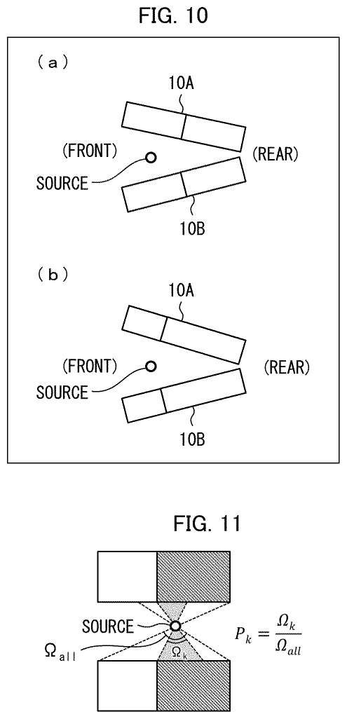

FIG. 10 is a schematic view illustrating an example of a difference in positions of division, as viewed from the sides of the detecting elements of the radiation detecting sections 10A and 10B. (a) of FIG. 10 illustrates an example in which division into the detecting elements is made such that the front parts and the rear parts become equal. (b) of FIG. 10 illustrates an example in which division into the detecting elements is made such that the positions of division become closer to the front. That is, the detecting elements in the front parts of the radiation detecting sections 10A and 10B are small in volume, and the detecting elements in the rear parts of the radiation detecting sections 10A and 10B are large in volume. These positions of division make it possible for the front parts, which frequently hold a tissue, to have an increased position discriminating ability, due to the characteristics that the accuracy of estimation of the position of the source is high in the vicinity of the above-described positions of division.

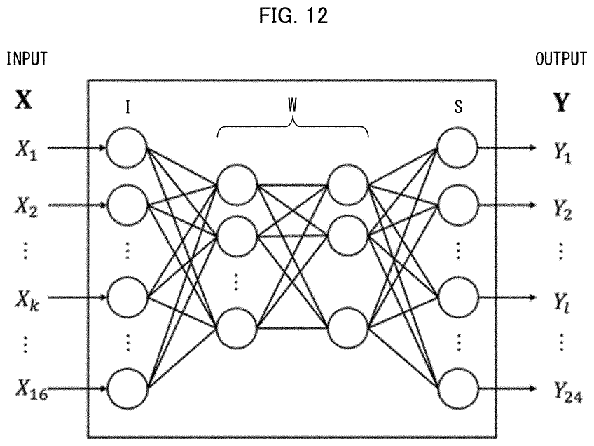

FIG. 11 is a schematic view illustrating that the counts in the combinations of the detecting elements vary depending on the position of the source. The rate Pk of the radiation detected with the upper and lower detecting elements hatched in FIG. 11 is expressed by the following equation (1).

$$P k = Ω k / Ω all \qquad ( 1 )$$

Note, here, that Ωk is a solid angle at which the upper and lower detecting elements hatched in FIG. 11 are looked ahead from the source, and Ωall is a total solid angle at which the upper and lower detecting elements are looked ahead from the source. Pk is set for each of the combinations of the detecting elements. That is, k=1 to 16. Since the rate of Ωk varies depending on the position of the source, it is possible to estimate the position with use of Pk.

As described with reference to FIGS. 4 to 6, the detection efficiency varies depending on the difference in method of opening and closing of the radiation detecting sections 10A and 10B and the position of the source. Thus, the correcting section 20 estimates the position of the source of the radiation from the detection data on the radiation, and further corrects the detection sensitivity. At this case, the correcting section 20 may estimate the position on the basis of actually measured values obtained by changing the spatial positions of the source and the radiation detecting sections 10A and 10B.

However, it may be realistically difficult to estimate the position of the source on the basis of actually measured data, because a large amount of actually measured data is needed. Thus, the correcting section 20 may estimate the position of the source of the radiation from the detection data, with use of the position estimation model 21 which has been trained in advance by machine learning. The position estimation model 21 is, for example, a regression model which employs a neural network, and is a position estimation model into which detection data corresponding to each of the combinations of the detecting elements is inputted and which outputs the position of the source.

FIG. 12 is a conceptual diagram illustrating a configuration of the position estimation model 21. As an example, in a case where the radiation detecting sections 10A and 10B illustrated in FIG. 10 are used, the position estimation model 21 includes, as an example, (i) an input layer I into which 16 pieces of detection data corresponding to the respective combinations of the detecting elements are each inputted as an input X, (ii) a plurality of hidden layers W, and (iii) an output layer S. Then, the position estimation model 21 outputs, as an example, the probabilities (likelihoods) of presence of the source in 24 sections on an xy plane as an output. Note that the position estimation model 21 may be a model into which, in addition to the detection data, a parameter that indicates spatial disposition of the pair of radiation detecting sections 10 is inputted. The spatial disposition of the radiation detecting sections 10 is, as described with reference to FIG. 6, disposition in which the radiation detecting sections 10A and 10B are opened and closed parallel to each other, disposition in which the radiation detecting sections 10A and 10B are opened and closed on the axis, or the like. The parameter is the distance D in the case of parallel opening and closing, the angle θ in the case of axial opening and closing, or the like. The distance D or the angle θ of the radiation detecting sections 10A and 10B can be measured by installing a sensor or the like to an opening and closing mechanism of the radiation detecting sections 10A and 10B. By inputting the measured parameter into the position estimation model 21, the correcting section 20 can cause a more accurate estimation result to be outputted.

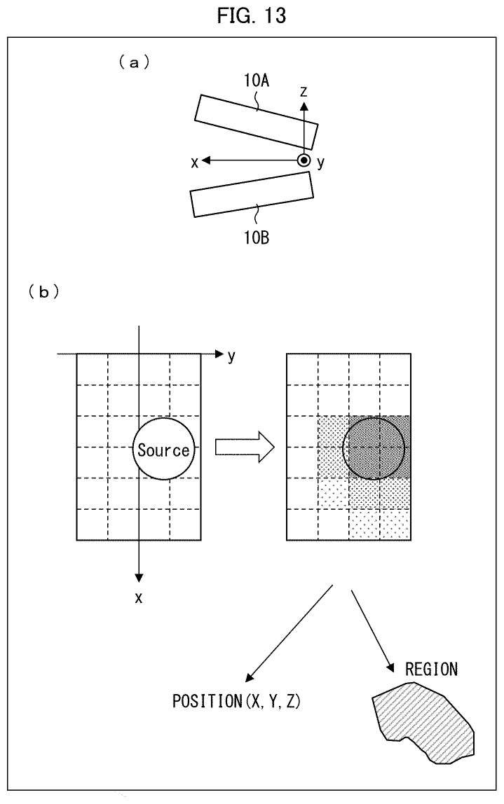

FIG. 13 is a schematic view illustrating the position of the source which position is outputted by the position estimation model 21. (a) of FIG. 13 illustrates the radiation detecting sections 10A and 10B of an axial opening and closing type as viewed from the sides thereof. As illustrated in (a) of FIG. 13, it is assumed that there is the xy plane halfway between the radiation detecting sections 10A and 10B, and the front-to-rear direction is regarded as an x axis and the left-right direction is regarded as a y axis. (b) of FIG. 13 illustrates the xy plane as viewed from a z axis direction. As illustrated in (b) of FIG. 13, the xy plane may be divided into 4×6=24 sections, and the position estimation model 21 may estimate the probability of presence of the source in each of the sections. In (b) of FIG. 13, the probability of presence of the source in each of the sections which is estimated by the position estimation model 21 is indicated by a shade. Furthermore, from the probabilities of presence of the source, the position estimation model 21 may estimate the central position (x, y, z) of the source of the radiation in a body tissue or may alternatively estimate a distribution (region) of the position of the source of the radiation in the body tissue, as illustrated in (b) of FIG. 13. Alternatively, from the probabilities of presence of the source which have been estimated by the position estimation model 21, the correcting section 20 may estimate the central position (x, y, z) of the source of the radiation in the body tissue or may alternatively estimate the distribution (region) of the position of the source of the radiation. In a case where the source of the radiation has the shape of a single sphere, the central position is the central position of the sphere. In a case where the source of the radiation has a shape other than the sphere, the central position may be referred to as the position of the center of gravity of the distribution of the source of the radiation. A method of training the position estimation model 21 will be described later.

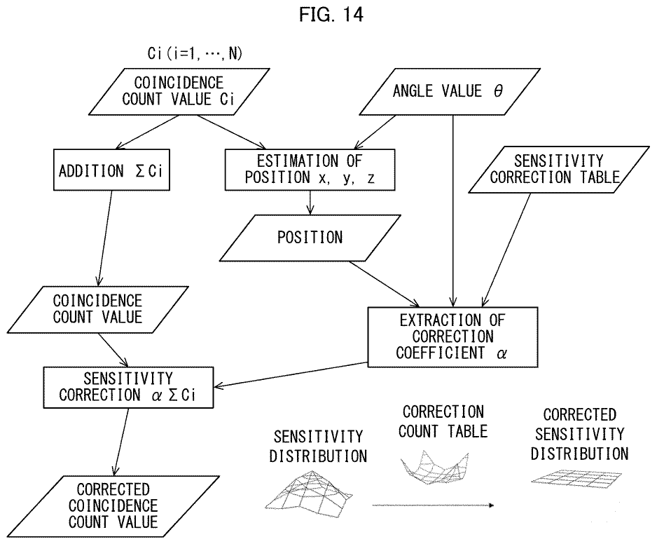

FIG. 14 is a schematic view illustrating a concept of correction carried out by the correcting section 20. The correcting section 20 obtains (i) a coincidence count value Ci (i=1, 2, . . . . N) which is the detection data obtained by the radiation detecting sections 10A and 10B and (ii) an angle value θ. In the above example, N=16. The coincidence count value Ci is obtained for each of the combinations of the detecting elements. The angle value θ is an example of the parameter that indicates the spatial disposition of the pair of radiation detecting sections 10A and 10B.

The correcting section 20 estimates the position of the source from the coincidence count values Ci and the angle value θ. The correcting section 20 determines a coefficient α for correcting the detection sensitivity with use of, in addition to the position of the source that has been estimated, (i) a sensitivity correction table that includes reciprocals of values normalized based on a detection sensitivity distribution so that the intensity of the source of the radiation becomes uniform, the detection sensitivity distribution being a distribution that has been obtained in advance and that varies depending on the position of the source of the radiation and (ii) the angle value θ (the parameter that indicates the spatial disposition of the pair of radiation detecting sections). A method of determining this correction coefficient α will be described later.

The correcting section 20 further derives a coincidence count value that is obtained by carrying out sensitivity correction by multiplying the total value (ΣCi) of the coincidence count values Ci by the correction coefficient α. The radiation measuring device 1 may include an output section that outputs the derived coincidence count value. By referring to the coincidence count value outputted, an operator of the radiation measuring device 1 can accurately estimate the amount of the source in the body tissue of a measurement target, that is, the amount of the PET test drug that is accumulated, without underestimation. FDG, PSMA, and the like are known to be accumulated in many cancerous tissues, and the amount of this accumulation can be used to diagnose the presence or absence of a cancerous tissue.

Thus, the radiation measuring device 1 in accordance with the present embodiment makes it possible to obtain a measured value for accurately estimating radioactivity in a case where coincidence counting type radiation detecting sections are used. Therefore, measurement data measured during an operation with use of the radiation measuring device 1 can be used as it is to diagnose the presence or absence of a cancerous tissue.

### (Radiation Measuring Method)

Next, a radiation measuring method S1 in accordance with the present embodiment is described. FIG. 2 is a flowchart illustrating a flow of the radiation measuring method S1. As illustrated in FIG. 2, the radiation measuring method S1 is a radiation measuring method for measuring the radiation from the body tissue, and includes steps S11 and S12. In the step S11, the correcting section 20 estimates the position of the source of the radiation from the detection data obtained by the pair of radiation detecting sections 10A and 10B each of which includes the plurality of radiation detecting elements. Next, in the step S12, the correcting section 20 corrects the detection sensitivity of the pair of radiation detecting sections with respect to the radiation on the basis of the position of the source of the radiation that has been estimated.

The radiation measuring method S1 may be executed by a program. For example, this program is a program for causing a computer to execute the steps of (i) estimating the position of the source of the radiation from the detection data obtained by the pair of radiation detecting sections each of which includes the plurality of radiation detecting elements and (ii) correcting the detection sensitivity of the pair of radiation detecting sections with respect to the radiation on the basis of the position of the source of the radiation that has been estimated.

The radiation measuring method S1 make it possible to obtain a measured value for accurately estimating radioactivity in a case where coincidence counting type radiation detecting sections are used, similarly to the effect of the radiation measuring device 1.

### Embodiment 2

The following description will discuss another embodiment of the present invention. Note that, for convenience, members having the same functions as those of the members described in the above embodiment are given respective identical reference numerals, and descriptions of those members are omitted.

### (Body Tissue Moving Method)

With reference to the position of a source that has been estimated by a correcting section 20 as in Embodiment 1, it is possible to move a body tissue in which the source is contained. Specifically, in this method, in an operation in which a medical robot is used, the position of the body tissue (i.e., the source) is estimated from a result of measuring radiation in the body tissue. In a case where the body tissue is not located in the vicinity of the centers of radiation detecting sections 10, the source is moved to the vicinity of the centers of the radiation detecting sections 10. A body tissue moving method S2 is described below.

The body tissue moving method S2 includes the steps of (i) estimating the position of the body tissue from detection data on the radiation that is from the body tissue and that has been detected by the pair of radiation detecting sections each of which includes a plurality of radiation detecting elements and (ii) moving the body tissue to a position at which the detection sensitivity of the radiation detecting sections is relatively high. The body tissue moving method will be described in more detail with reference to the drawing.

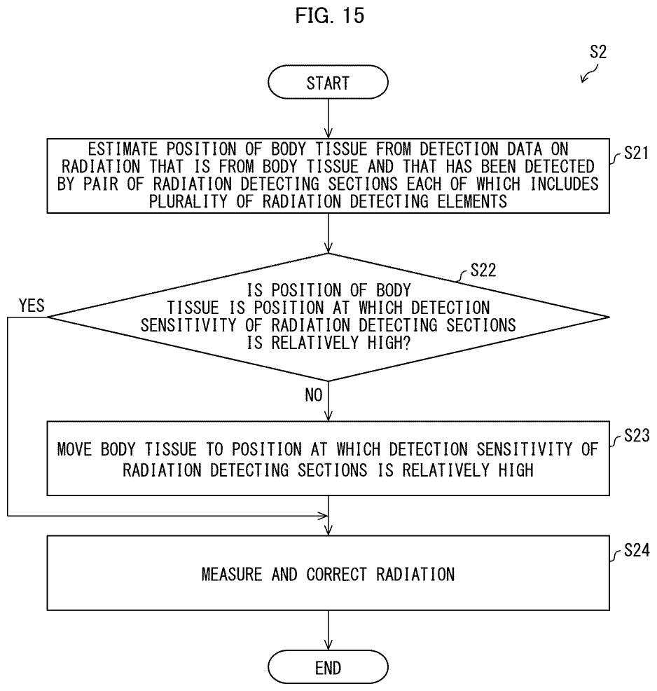

FIG. 15 is a flowchart illustrating a detailed flow of the body tissue moving method S2. As illustrated in FIG. 15, the body tissue moving method S2 includes steps S21 to S24. In the step S21, the correcting section 20 estimates the position of the body tissue from the detection data on the radiation that is from the body tissue and that has been detected by the pair of radiation detecting sections each of which includes the plurality of radiation detecting elements. The radiation detecting sections 10 include a pair of radiation detecting sections 10A and 10B, as described in Embodiment 1.

In the step S22, the correcting section 20 determines whether or not the position of the body tissue is the position at which the detection sensitivity of the radiation detecting sections 10 is relatively high. The position at which the detection sensitivity is relatively high is the vicinity of the centers of the radiation detecting sections. In a case where it is determined, in the step S22, that the position of the body tissue is the position at which the detection sensitivity of the radiation detecting sections 10 is relatively high (Step S: YES), the method proceeds to the step S24, and the correcting section 20 corrects the measured radiation.

On the other hand, in a case where it is determined, in the step S22, that the position of the body tissue is not the position at which the detection sensitivity of the radiation detecting sections 10 is relatively high (Step S: NO), the method proceeds to the step S23, and the body tissue is moved to the position at which the detection sensitivity of the radiation detecting sections is relatively high. Specifically, the correcting section 20 controls the medical robot to move the body tissue to the position at which the detection sensitivity is relatively high. Then, the method proceeds to the step S24, and the correcting section 20 measures the radiation again and corrects the measured radiation.

This method makes it possible to move the body tissue with use of information on the position of the body tissue (source) that has been estimated, and makes it possible to move the body tissue to the position at which the detection sensitivity is higher. Then, by measuring the radiation again, it is possible to highly accurately measure the radiation. Note that, instead of the body tissue being moved, the radiation detecting sections may be moved so that the body tissue is disposed at the position at which the detection sensitivity is relatively high.

### Embodiment 3

The following description will discuss another embodiment of the present invention. Note that, for convenience, members having the same functions as those of the members described in the above embodiments are given respective identical reference numerals, and descriptions of those members are omitted.

### (Method of Training Position Estimation Model 21)

In the present embodiment, a method of training the position estimation model 21 described in Embodiment 1 is described. In the present embodiment, described is an example of the method of training the position estimation model 21 that has been described in Embodiment 1 and that estimates the position of the source from the detection data measured by the pair of radiation detecting sections 10A and 10B each of which is divided into four detecting elements.

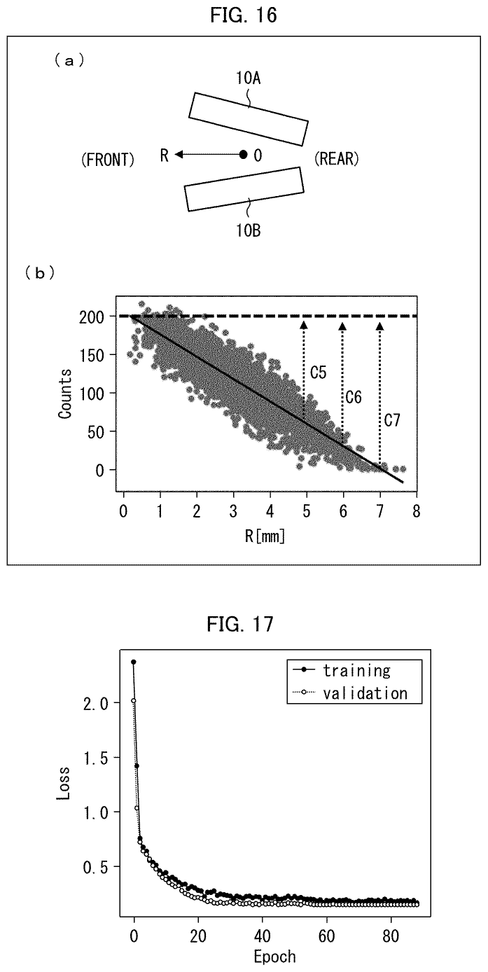

FIG. 16 is a schematic view illustrating the detection data obtained by the radiation detecting sections 10A and 10B and a concept of correction of the detection data. (a) of FIG. 16 illustrates coordinates of the source with respect to the radiation detecting sections 10A and 10B. R is a distance from a detector center O to the source (x, y, z) of the radiation. (b) of FIG. 16 shows an example of a detection value measured at the position R of the source. As the general tendency, as the distance R from the center O of the radiation detecting sections 10A and 10B to the source of the radiation becomes longer, the detection value becomes lower, as shown in (b) of FIG. 16. Therefore, it is necessary to correct the detection value so that the detection value has the same value regardless of the position of the source. In a case where a desired measured value is 200, a correction coefficient is set such that a corrected value becomes 200. For example, the corrected value of 200 is obtained in a case where the detection data in the case of R=5 is multiplied by a correction coefficient C5, the detection data in the case of R=6 is multiplied by a correction coefficient C6, or the detection data in the case of R=7 is multiplied by a correction coefficient C7. By setting such correction coefficients on all the positions of the source, the correction coefficient α is obtained. For simplicity, in this example, the distance R as the radiation source information, in which a dimension number (coordinates in three-dimensional directions) is reduced, is used as a correction factor. Alternatively, detection value characteristics may be investigated with regard to each of the x, y, and z directions so as to use three independent correction factors (or four independent correction factors in a case where the distance D or the opening and closing angle θ is included).

Training data for training the position estimation model 21 is created by computer simulation. That is, radiation (annihilation gamma rays) is generated randomly in accordance with the half-life of 18F with use of a computer. In a case where the radiation passes through the detecting elements, it is evaluated that the radiation is detected by the detecting elements. Simulation conditions are as follows, as an example. First, a lymph node that is the body tissue is assumed to have the shape of a sphere, and composition is assumed to be water. The size of the sphere is assumed to be 5 mm in diameter. This lymph node is placed randomly between 7.5 mm and 12.5 mm from the innermost parts of the radiation detecting sections. The degree 0 of opening of the radiation detecting sections 10A and 10B between which the lymph node is sandwiched is defined by the position of the lymph node having a diameter of 5 mm.

As the source distributed inside the lymph node, a spherical source containing ¹⁸F having radioactivity of 600 Bq is used. The size of the sphere is set randomly in a range from 0.2 mm to 4.8 mm in diameter. The position of the spherical source is a random position inside the lymph node. Note, however, that the position is set such that the sphere does not protrude from the lymph node.

Time for which the radiation detecting sections 10 carries out measurement is set to 30 seconds. A coincidence time window (one count is made as a coincidence count, in a case where the radiation is detected with opposing detecting elements within this time) is set to 12 ns. A coincidence energy window (in a case where two rays of radiation have radiation energy falling within this range, the two rays of radiation are evaluated as annihilation gamma rays) is set to 400 keV-600 keV. Dead time (after the detecting elements have detected the radiation once, the detecting elements cannot carry out next detection during this dead time) is set to 256 ns.

Under the above simulation conditions and under various source conditions and positional conditions, 15,000 measurement data sets are generated. Among the generated data sets, 3,000 sets are used as training data for the position estimation model 21 so as to cause the position estimation model 21 to learn an optimal conversion function F(P1, P2, . . . , P16)=(x, y, z) that fits to 3,000 (P1, P2, . . . , P16)→(x, y, z). Note that P1 to P16 are each Pk described with reference to FIG. 11. Among the remaining data sets, 3,000 sets are used as validation data, and 9,000 sets are used as test data (evaluation data). First, the position estimation model 21 is trained with use of the training data, and parameters are obtained. The validation data is used for evaluation of the position estimation model at a training stage (the generalization performance of the trained model can be verified). In the training, in a case where a loss value is not improved with respect to the validation data in 30 epochs, the training is stopped. Next, with use of the test data, the position estimation accuracy and the coincidence count value estimation accuracy of the position estimation model 21 are evaluated.

The position estimation model 21 is a machine learning model into which coincidence counts corresponding to 16 combinations of the detecting elements are inputted and which outputs the coordinates (x, y, z) of the central position of the source distribution. The network structure of the position estimation model 21 is a neural network structure including an input layer, three hidden layers (the numbers of neurons are respectively 128, 128, and 64), and an output layer. A loss function is a mean square error, and is optimized by an RMSprop optimizer.

In evaluation of the position estimation accuracy of the position estimation model 21, used is an error between a true value (simulation conditions) of the coordinates of the central position of the source distribution and a value estimated by the position estimation model 21. Specifically, the true value is set as wt1=[xt1, yt1, zt1], the estimated value is set as wp1=[xp1, yp1, zp1], and an error ε1=wp1−wt1=[xp1−xt1, yp1−yt1, zp1−zt1] is calculated. In evaluation of the sensitivity correction, the average value and the standard deviation of radioactivity values before and after the sensitivity correction are used as evaluation indexes. At this time, similarly to the evaluation of the position estimation model 21, the average value and the standard deviation of the radioactivity values which are calculated for each specified range are used as evaluation indexes.

FIG. 17 is a graph showing a result of training the position estimation model 21 under the above-described conditions. The graph shows the relationship between the number of training (epochs) on the horizontal axis and loss on the vertical axis. In both the training stage (training) and a validation stage (validation), the loss decreases to a sufficiently low level at around 20 epochs. This indicates that the training progresses.

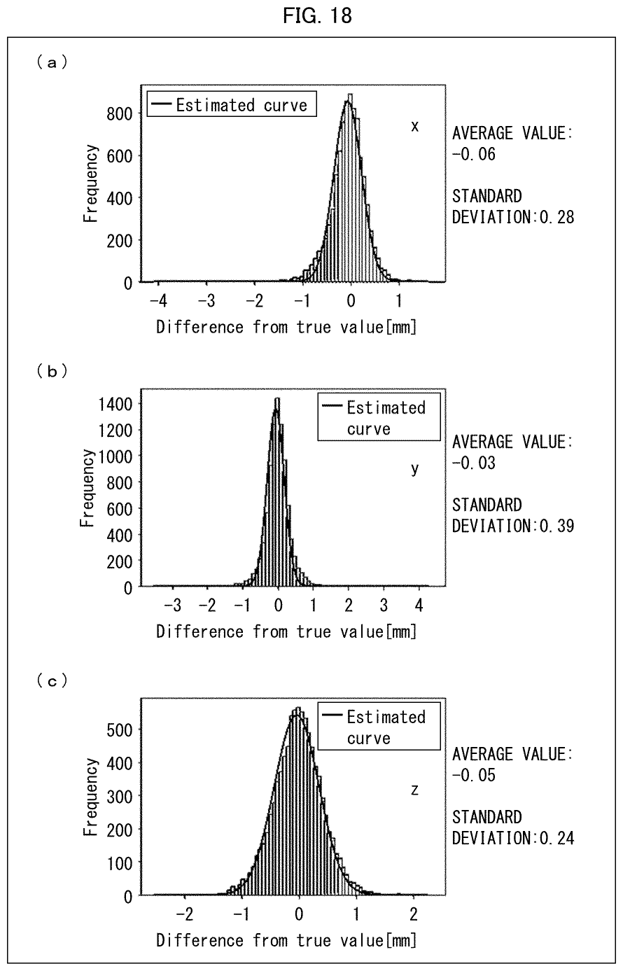

FIG. 18 includes graphs each showing accuracy of estimation which the position estimation model 21 carried out in each axial direction with respect to all data on coincidence count values. (a) of FIG. 18 is a histogram showing the frequencies of errors of estimated values from a true value in the x axis direction. (b) of FIG. 18 is a histogram showing the frequencies of errors of estimated values from a true value in the y axis direction. (c) of FIG. 18 is a histogram showing the frequencies of errors of estimated values from a true value in the z axis direction. Curves in FIG. 18 are each an approximate curve of a normal distribution of the frequencies. On the right side of each graph, an average value and a standard deviation which are calculated by fitting the approximate curve of the normal distribution. In each axis, the average value of the errors is −0.03 mm to −0.06 mm, and the standard deviation is 0.24 mm to 0.39 mm, i.e., accurate estimated values are obtained.

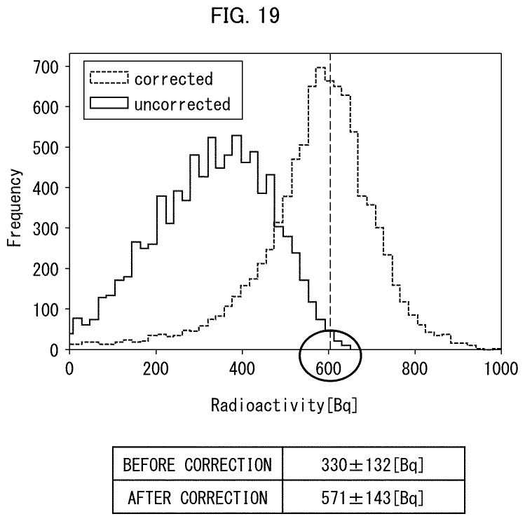

FIG. 19 shows a histogram of estimated values of radioactivity before and after the sensitivity correction (the vertical axis indicates frequencies). An ideal value is 600 Bq. The estimated value before the correction is 330±132 [Bq]. In contrast, the estimated value after the correction is 571±143 [Bq]. Thus, it is found that both dispersion and underestimation of radioactivity are improved.

The present invention is not limited to the embodiments, but can be altered by a skilled person in the art within the scope of the claims. The present invention also encompasses, in its technical scope, any embodiment derived by combining technical means disclosed in differing embodiments.

Aspects of the present invention can also be expressed as follows:

### (Aspect 1)

A radiation measuring device which is of a forceps type and which measures radiation from a body tissue, including: a pair of radiation detecting sections each of which includes a plurality of radiation detecting elements; and a correcting section which estimates a position of a source of radiation from detection data obtained by the pair of radiation detecting sections and which corrects detection sensitivity of the pair of radiation detecting sections with respect to the radiation on the basis of the position of the source of the radiation that has been estimated.

### (Aspect 2)

The radiation measuring device as described in Aspect 1, wherein the correcting section estimates the position of the source of the radiation from the detection data with use of a position estimation model which has been trained in advance by machine learning.

### (Aspect 3)

The radiation measuring device as described in Aspect 2, wherein the position estimation model is a model into which, in addition to the detection data, a parameter that indicates spatial disposition of the pair of radiation detecting sections is inputted.

### (Aspect 4)

The radiation measuring device as described in Aspect 3, wherein the correcting section determines a coefficient for correcting the detection sensitivity with use of, in addition to the position of the source of the radiation that has been estimated, (i) a sensitivity correction table that includes reciprocals of values normalized based on a detection sensitivity distribution so that intensity of the source of the radiation becomes uniform, the detection sensitivity distribution being a distribution that has been obtained in advance and that varies depending on the position of the source of the radiation and (ii) the parameter that indicates the spatial disposition of the pair of radiation detecting sections.

### (Aspect 5)

The radiation measuring device as described in any one of Aspects 1 through 4, wherein the correcting section estimates a central position of the source of the radiation in a body tissue.

### (Aspect 6)

The radiation measuring device as described in any one of Aspects 1 through 4, wherein the correcting section estimates a distribution of the position of the source of the radiation in the body tissue.

### (Aspect 7)

The radiation measuring device as described in any one of Aspects 1 through 6, wherein a volume of one or more of the plurality of radiation detecting elements which are located in a front part of each of the pair of radiation detecting sections is smaller than a volume of one or more of the plurality of radiation detecting elements which are located in a rear part of the each of the pair of radiation detecting sections.

### (Aspect 8)

A radiation measuring method for measuring radiation from a body tissue, including the steps of: estimating a position of a source of radiation from detection data obtained by a pair of radiation detecting sections each of which includes a plurality of radiation detecting elements; and correcting detection sensitivity of the pair of radiation detecting sections with respect to the radiation on the basis of the position of the source of the radiation that has been estimated.

### (Aspect 9)

A radiation measuring program for causing a computer to execute the steps of: estimating a position of a source of radiation from detection data obtained by a pair of radiation detecting sections each of which includes a plurality of radiation detecting elements; and correcting detection sensitivity of the pair of radiation detecting sections with respect to the radiation on the basis of the position of the source of the radiation that has been estimated.

### (Aspect 10)

A body tissue moving method including the steps of: estimating a position of a body tissue from detection data on radiation that is from the body tissue and that has been detected by a pair of radiation detecting sections each of which includes a plurality of radiation detecting elements; and moving the body tissue to a position at which detection sensitivity of the pair of radiation detecting sections is relatively high.

### (Aspect 11)

A computer-readable non-transitory recording medium in which a radiation measuring program described in Aspect 9 is recorded.

### REFERENCE SIGNS LIST

1 Radiation measuring device
10 Radiation detecting section
20 Correcting section
21 Position estimation model

1. A radiation measuring device which is of a forceps type and which measures radiation from a body tissue, comprising:
a pair of radiation detecting sections each of which includes a plurality of radiation detecting elements; and
a correcting section which estimates a position of a source of radiation or a distribution of the position or both of the position and the distribution of the position from detection data obtained by the pair of radiation detecting sections and which corrects detection sensitivity of the pair of radiation detecting sections with respect to the radiation from the source with use of, in addition to the position of the source of the radiation or the distribution of the position or both of the position and the distribution of the position each of which has been estimated, a sensitivity correction table that includes reciprocals of values normalized based on a detection sensitivity distribution so that intensity of the source of the radiation becomes uniform, the detection sensitivity distribution being a distribution that has been obtained in advance and that varies depending on the position of the source of the radiation.

2. The radiation measuring device as set forth in claim 1, wherein the correcting section estimates the position of the source of the radiation or the distribution of the position or both of the position and the distribution of the position with use of, in addition to the detection data, a parameter that indicates spatial disposition of the pair of radiation detecting sections, with use of a position estimation model which has been trained in advance by machine learning.

3. (canceled)

4. The radiation measuring device as set forth in claim 31, wherein the correcting section determines a coefficient for correcting the detection sensitivity with use of (i) the sensitivity correction table and (ii) the parameter that indicates the spatial disposition of the pair of radiation detecting sections.

5. (canceled)

6. (canceled)

7. (canceled)

8. A radiation measuring method for measuring radiation from a body tissue, comprising the steps of:
estimating a position of a source of radiation or a distribution of the position or both of the position and the distribution of the position from detection data obtained by a pair of radiation detecting sections each of which includes a plurality of radiation detecting elements; and
correcting detection sensitivity of the pair of radiation detecting sections with respect to the radiation from the source with use of, in addition to the position of the source of the radiation or the distribution of the position or both of the position and the distribution of the position each of which has been estimated, a sensitivity correction table that includes reciprocals of values normalized based on a detection sensitivity distribution so that intensity of the source of the radiation becomes uniform, the detection sensitivity distribution being a distribution that has been obtained in advance and that varies depending on the position of the source of the radiation,
the steps being executed with use of a radiation measuring device recited in claim 1.

9. (canceled)

10. A body tissue moving method comprising the steps of:
estimating a position of a body tissue from detection data on radiation that is from the body tissue and that has been detected by a pair of radiation detecting sections each of which includes a plurality of radiation detecting elements; and
moving the body tissue to a position at which detection sensitivity of the pair of radiation detecting sections is relatively high.

11. (canceled)
